(19) United States
(12) Patent Application Publication
(10) Pub. No.: US 2014/0040029 A1
(43) Pub. Date: Feb. 6, 2014

(54) SYSTEMS AND METHODS FOR ORGANIZING AND DISPLAYING SOCIAL MEDIA CONTENT

(71) Applicant: Omega Intelligence, Inc., Park Ridge, IL (US)

(72) Inventor: Abid Vhora, Park Ridge, IL (US)

(73) Assignee: Omega Intelligence, Inc., Park Ridge, IL (US)

(21) Appl. No.: 13/844,056

(22) Filed: Mar. 15, 2013

Related U.S. Application Data
(60) Provisional application No. 61/679,678, filed on Aug. 3, 2012.

(51) Int. Cl. H04L 29/08

(52) U.S. Cl. CPC H04L 67/22
USPC 705/14.54; 709/204

(57) ABSTRACT

A system for dynamically presenting and organizing social media by subject matter includes: a posting database including a plurality of posts, wherein each post includes post content and one or more post tags; and a display engine posting the plurality of posts to a client machine, wherein the plurality of posts are posted in response to receiving a post tag selection from the client machine.

### CROSS-REFERENCE TO RELATED APPLICATIONS

This application incorporates by reference and claims priority to U.S. Provisional Application No. 61/679,678 filed Aug. 3, 2012.

### BACKGROUND OF THE INVENTION

The present invention relates generally to dynamic news presentation and advertising in social media, and more particularly to systems and methods for dynamically presenting and organizing news items and advertising for a particular person by subject matter.

It seems that most content in popular social media platforms takes the form of status updates or posts that are contributed by users, and subsequently may be pushed out to others who are friends or followers of the users. Social media platforms may allow users to post text status updates, as well as links, photos, and videos. Based on current usage statistics from a popular social media platform, a rough estimate shows that the typical user receives well over 1,000 items per week from an average of 130 friends.

In a recent survey, a growing user base is spending less time on social media platforms than six months prior. Some of the reasons cited were that the sites were boring, not relevant, or not useful. It seems that the content is organized by either most recent or most commented/liked items and does not appear to take into account the preference for specific users. This may clog up users' news feed with irrelevant stories and may make social media platforms feel impersonal.

Gross level settings like blocking and hiding, specifying friends and applications you may not want to receive content from and specifying individuals from whom you may like to see more content, may not be easy to manage from a user perspective. Currently, social media platforms also seem to lack the ability of users to customize the presentation of content to their desired needs and interests.

The researchers have also found that one in three users felt worse after visiting the social media platforms and more dissatisfied with their lives. This may be correlated to users seeing stories they do not want to see, such as a previous partner getting married. According to these experts, some of these users may then leave or at least reduce their use of the social media platforms.

Recently, social media platforms seem to be a source of news and current events for users as well. However, such news and analysis may be mingled with vacation photos and baby posts as such, key content may be lost in the shuffle. One possible way to retrieve the lost content is users may search the content using search features available on social media platforms and on the web. However, the relationship between similar content seems to be disregarded. In instances where a search query is not matched, users may be shown irrelevant content.

In addition to social media platforms' potential influence on users, advertisers may be attracted to social media platforms due to their massive access to people and data. It appears that the primary method of revenue for various social media platforms is advertising.

On these networks, it seems that the users are bombarded with various forms of irrelevant advertising, without taking into account user's preference for content or privacy. A majority of users rarely or never click on advertisements on social media platforms according to various recent surveys. Even if users do engage with advertisement, that engagement may not last for long.

The format for advertising on the web and social media platforms seems outdated and may be ignoring various user variables. The current advertising format seems static, in other words, advertising may not take into account changes in user and content. Inability of advertisers to understand and adjust for these variables may lead to growth in ineffective advertising. In addition, advertising platforms may not be capitalizing on selling more advertisements as users scroll through a page since currently only a handful of advertisements are allocated to a single page.

In addition, the advertising on the social media platforms does not seem to be organically mixed with user data and users may easily be able to dismiss it. The problem also may be that current advertising does not covey value-added information to compel users to click the advertisements. It appears that the current advertising platforms require users to leave the network to purchase the content advertised, and as such, the purchase process on the networks may be time consuming and not user-friendly.

Furthermore, advertising seems impersonal and may not to be helping users with their purchase decisions. Users appear to have limited ability to communicate with advertisers aside from visiting the advertiser's content page. Current format does not seem to support multi-tasking where users may interact with advertisers without stopping their current activity on social media platforms.

Companies alike seem to be losing out on benefits of the social media platforms. Users seem to typically be enticed by companies through discounts or previews to provide positive acknowledgements for the company. This may not reflect how much users actually use or support the brand.

Accordingly, there is a need for a method for organizing and displaying posts in a social media provider or any source of posted content, as described and claimed herein.

### BRIEF SUMMARY OF THE INVENTION

The present disclosure provides a method for organizing and displaying posts in a social media provider or any source of posted content is described. The method includes automatically generating a display that contains information relevant to a user which may be organized by tabs of relevant topics or a similar format, wherein the organization may be defined by a user selection from provided options. Within each subject area, the content may be presented relevant to user interests. This may also enable users to create settings per subject area, such as preferred sources. This may allow users to process the information easily by subject and set the content they may like to see.

To possibly further organize content, the method may allow a user an option to flag certain items which a user deems to be important to be viewed by themselves or associated users and maintain it for a given amount of time or until removed. This may allow users to readily locate important content. To further discover content, users may perform searches, possibly within a subject area. User interest and proximity may be taken into account for the search. Proximity may include physical location, educational background, age, gender, or other information found in user profiles. Users may also be allowed to filter by date, events, and/or groups (family, friends etc.). If an exact match does not exist for a search query, the next best results may be determined with the connection to the original search. This allows users to locate key content more accurately and return search results with possibly more intuitive connections.

The method may further appeal to users by making advertisement more relevant and effective for any platform with user profile data and content. Advertisement may be displayed based on relevancy to currently viewed content and basic profile information, including location, gender, age, etc. The method may dynamically update the advertising as a user maneuvers through the page and the content is updated or as a user is viewing content for longer periods of time, such as a video. In this case, the advertisement may be specific to the genre of the video. It may also dynamically update advertisement content for a specific user, such as the color and the gender of the models shown. If directly relevant advertising content is not available, the next best related advertisement may be shown. Furthermore, the method may allow for predictive advertising which may include predictive behavior of user actions or preference determined using historical data located within the social media platform or other sources, such as car and house purchasing data to predict what stage in life people typically buy them.

The method may additionally allow advertisement to become more engaging by providing value-added content which may include social media content such as company pages, comments, likes, check-ins, and coupon/discounts. Discounts may be from third parties which may provide affiliated revenue for social media platforms.

The method may also allow a higher degree of interaction between a user and advertisement. For instance, a user may purchase items without leaving the platform and preferences based on profile data may be determined and/or saved, including size, shipping information, etc. Companies may also provide a more personalized connection to users by presenting best value offers to help a user make the best purchasing decision. The method may further allow users to interact with companies by posting questions directly on the advertising page, which may or may not be displayed to the public. A user may receive response notifications of the answers via standard post notifications.

In yet another method, users may more directly associate with companies by setting and/or creating their own advertisement. Users may select from a list of advertisement and/or may create their own, such as a graphic or video. This may get displayed in a user profile by default or based on viewing users' interests. This may allow users to create their own brand and crowd source. Companies may also more accurately understand their brand recognition and trust.

A system for dynamically presenting and organizing social media by subject matter may include: a posting database including a plurality of posts, wherein each post includes post content and one or more post tags; and a display engine posting the plurality of posts to a client machine, wherein the plurality of posts are posted in response to receiving a post tag selection from the client machine. Each post may be associated with user data associated with a profile database, further wherein the user data associated with each post includes a grant for the first user to access the post.

The display engine may provide a currently viewed post and an advertising generator engine may select an advertisement from an advertisement database based on a keyword comparison between keyword data associated with the currently viewed post and keyword data associated with the selected advertisement. The selected advertisement may be displayed in association with the currently viewed post.

The display engine may display a news feed based on at least one user selected tag received through a personalization component, further wherein an advertising generator engine may select an advertisement from an advertisement database based on a keyword comparison between keyword data associated with the at least one user selected tag and keyword data associated with the advertisement. The display engine may then display the selected advertisement in association with the currently viewed post.

As noted, the display engine may provide a currently viewed post. In such instances, an advertising generator engine may select an advertisement including a static portion and a dynamic portion from an advertisement database based on a keyword comparison between keyword data associated with the currently viewed post and keyword data associated with the advertisement. The advertising generator engine may select from amongst a plurality of dynamic advertisement content associated with the selected advertisement based on data received from a profile database and the display engine may display the selected advertisement including the selected dynamic advertisement content in association with the currently viewed post.

A search engine may receive a search request from a client machine and identify a related one or more posts from a posting database. The display engine may further cause the identified one or more posts to be displayed on the client machine and the identified one or more posts may be displayed in prioritized order based at least in part on data received from a profile database.

In another example, a system for dynamically presenting and organizing social media by subject matter may include: a news feed engine adapted to assemble a list of one or more posts from a posting database, wherein each post includes post content and one or more post tags, further wherein the news feed engine assembles the list of one or more posts based on a comparison of the post tags and at least one user selected tag received through a personalization component; and a display engine adapted to display the post content assembled list of one or more posts in a news feed associated with a first user.

The personalization component may be further adapted to receive user selected preferences that instruct the display engine as to the format in which to display the assembled list of one or more posts from the posting database. The display engine may display the assembled list of one or more posts in prioritized order based on relevancy to data associated with the first user in a profile database. In another example, the display engine displays the assembled list of one or more posts in prioritized order based on relevancy to data associated with the first user in a posting database.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1A illustrates an exemplary environment for social tagging in a social media environment.

FIG. 1B is a diagram of an exemplary environment of an advertising management system.

FIG. 2 is an exemplary screenshot of a social tagging page;

FIG. 3A is an illustration of posts and related social advertising, according to one embodiment.

FIG. 3B is a continued illustration of the advertising page.

FIG. 4 is an illustration of a profile and related social advertising, according to one embodiment.

FIG. 5 is a flow diagram of an exemplary process for generating a social tagging page.

FIG. 6 is a flow diagram of an exemplary process for generating a post in a social tagging page.

### DETAILED DESCRIPTION OF THE INVENTION

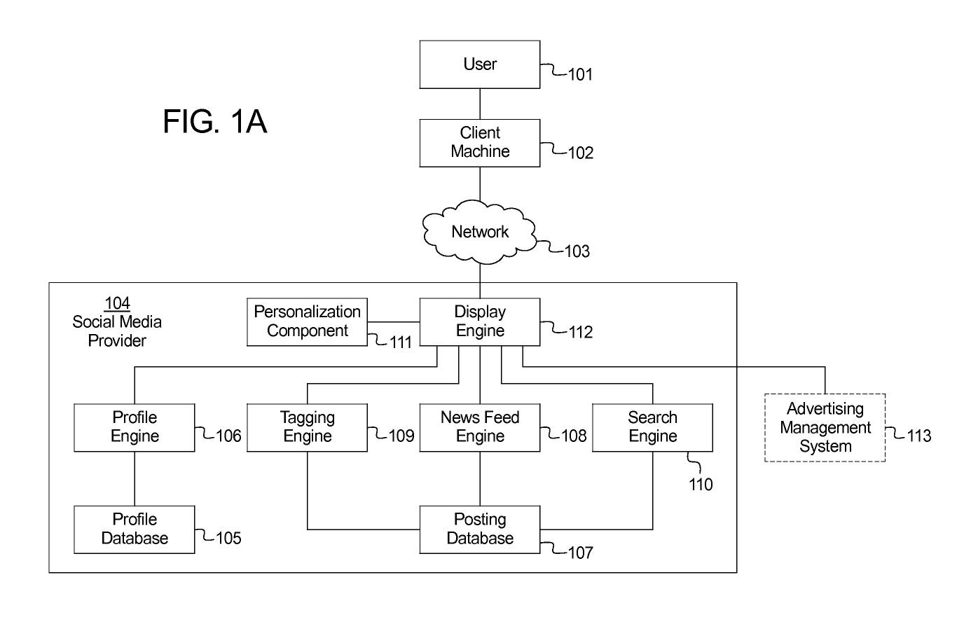

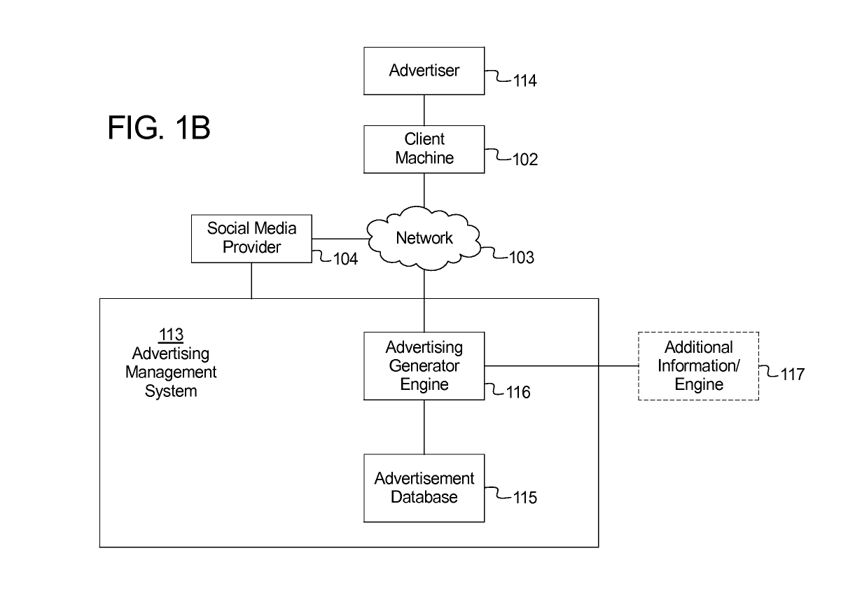

FIG. 1A illustrates an exemplary environment for social tagging in a social media environment. One or more users, such as user 101, utilize a client machine 102, which may include personal computers, mobile communication devices, and other devices that may send and receive data over a network 103. A client machine 102 typically includes a user application, such as a web browser or other communication software, to facilitate the sending and receiving of data to access a social media provider 104 via a network 103.

A social media provider 104 may comprise any entity that provides social media services. For example, a social media provider 104 may enable a user 101 to store information in a profile that may be viewed via a client machine 102 and to selectively grant access to information that appears on the profile to other users 101 who may also view the profile at their client machines 102.

A profile database 105 is provided for storing data associated with a user 101. User profile information may include user data, such as interests, contact information, and profile picture, and specifically may include relationship information to establish associated users. When a user 101 subscribes to services provided by a social media provider 104, a user profile may be generated for a user 101. When a user 101 adds additional information to a user profile, such as adding an interest, the user profile in a profile database 105 may be updated with the information. A user profile may be stored, modified, added, and so forth to any storage medium.

A profile engine 106 is used to retrieve relevant information from a profile database 105 when a user 101 accesses a social media provider 104. Basic information and pictures may be retrieved based on privacy settings. Associated users may also be retrieved.

A posts database 107 contains any form of sharing such as photos, check-ins, news items, website links, and comments in a social media provider 104. When a user 101, adds a post such as a check-in, a posts database 107 may be updated with the information. Posts may be stored, modified, added, and so forth to any storage medium.

In one instance, a viewing user 101 associated with a user device 102 requests to view posts via a social media platform associated with a social media provider 104. In this case, a news feed engine 108 may assemble a list of one or more items from a posting database 107 for display to a user 101. A news feed engine 108 may order posts chronologically and based on filtering by user 101.

A personalization component 111 may contain customizations specific to a user 101 to be applied upon post(s) retrieved by a news feed engine 108, search engine 110, or profile engine 106 and displayed via the display engine 112. Customization examples may include tab, priority, user, and advertising settings.

A display engine 112 may display one or more items of content from a profile engine 106, new feed engine 108, and advertising management system 113. For specific user 101 actions, tagging engine 109 and search engine 110 results may also be presented via a display engine 112. A personalization component 111 may specify any formatting settings for the display engine 112. Users 101 may interact with a social media provider 104 via a display engine 112.

A tagging engine 109 may be used to tag posts when they are first generated and added to a posting database 107. When a user 101 creates a post, they may be displayed with a default tag from the available options based on the subject of a post which may be determined by the link source or content. A user 101 may change a tag to another one from a dropdown list if they desire. Once a post is submitted, it may update a posting database 107 with the post content and tag. It may then be available for display to a user via a profile engine 106 and associated users via a news feed engine 108. The subject tagging may be used to display the post in a particular location, such as a tab.

In one embodiment, user may customize their tab settings including tab headings and order, which may be saved in the personalization component 111. A viewing user 101 associated with a user device 102 may then request to view categorized posts via a social media platform associated with a social media provider 104. Posts may be displayed by the display engine 112 to a user and associated users 101 based on the tab settings in the personalization component 111 matched to subject tag of the postings in the posting database 107.

According to some embodiments, a viewing user 101 associated with a user device 102 may request to view relevant posts via a social media platform associated with a social media provider 104. In this case, a news feed engine 108 may utilize data about a particular user 101 from a profile database 105 to assemble a list of one or more tagged items from a posting database 107 for display to a user 101 using the personalization component 111 which may also contain the format preference specified by the user 101 and displayed via the display engine 112. A news feed engine 108 may use interest and background data from a profile database 105 to display items based on relevancy to a user's interest and background from their own posts or ones from associated users as stored in a posting database 107. Relevancy may be determined by matching the subject tag of the posts to interest and background keywords generated for user 101, such as location and age, in the profile database 105.

A search engine 110 may be used to do a search through available postings from a posting database 107 of a user and associated users 101 within a tab. It may be performed on a tag, such as Sports, as well as content of a post. Results may be determined by matching the search keywords to the subject tag keyword and is then further matched to keywords in the posting content.

In one instance, a search engine 110 may show next best search results based on relevancy to user, which may include interest and proximity. The proximity may include physical location, educational background, age, gender, etc. A search engine 110 may use interest and proximity data from a profile database 105 to further refine subject keyword search results and display items based on relevancy to a user's interest and proximity from posts stored in a posting database 107. For example, a search for basketball by a user 101 who attended a Big Ten college and resides in Chicago may result in Big Ten basketball postings first and then postings about the Chicago Bulls basketball team.

An advertising management system 113 may contain all available advertisement content and associated keywords that may be displayed on a social media platform 104. An advertising management system 113 may be external to a social media platform 104; however, in some cases, it may be hosted by a social media platform 104. An advertising management system 113 may also be leveraged by another system that has basic user information. The advertising management system 113 may be called by the display engine 112 during passive activity, such as when a user 101 is viewing a post. Or in another embodiment, during an active call when a user 101 is performing a search via the search engine 110.

FIG. 1B is a diagram of an exemplary environment of an advertising management system 113. An advertiser 114 may maintain one or more advertising content with one or more identified keywords and rules in an advertisement database 115. Advertising data may include product information, coupons, flash deals, contact information, purchasing information, and locations/directions. Keywords may be supplied by an advertiser 114, or suggested by an advertising management system 113. Keywords may include direct ones that explicitly explain the content of the advertisement, such as basketball ticket for a ticket from a basketball vendor; informational keywords such as location; dynamic keywords such as gender; and related keywords such as March Madness and cheerleaders. The dynamic keywords may also have related content which may be stored in the advertisement database 115, such as in the case of gender keyword tags an associated image of a male model at a basketball game and another one for a female model at a basketball game may be stored. An advertiser 114 may use a client machine 102 over a network 103 to send advertisement content to an advertising management system 113. When an advertiser 114 adds advertisement, an advertisement database 115 may be updated with the information added. Advertisement may be stored, modified, added, and so forth to any storage medium. In one embodiment, a user 101 may also select either from an advertisement database 115 what advertisement they want displayed on their profile. Or if the advertiser 114 allows, a user 101 may create their own advertisement for the company and/or product, this may include a graphic, picture, or video and may be posted on the user 101 profile for relevant associated users 101. User generated advertisement may be updated in the personalization component 111 and advertisement database 115 if the company may want to use a user-generated advertisement as one of their standard advertisements. For example, if a user 101 really likes a straightening hair product they may create a video styling their hair with the product, and it may be shown on their page for all associated users who are female.

An advertiser 114 may also use a client machine 102 over a network 103 to register a social media provider 104 account with an advertising management system 113. By doing so, an advertiser 114 allows a social media provider 104 to access advertiser's data and content by, for instance an application programmable interface (API), or some other method.

The advertising generator engine 116 may also leverage information or engines 117 which may be external to the advertising management system 113. This information may be provided via an API, or some other method. Examples of advertising related items that may be leveraged externally, may include flash deals, other discounts, purchasing engines, usage and other statistics, best value algorithms, etc.

In one embodiment, when a user 101 from a social media provider 104 views a post with identified subject keywords, the display engine 112 may include a call to request advertisement from an advertising management system 113. Keyword information of the currently viewed posts, including the tag and content from the post database 107, may be passed to an advertising generator engine 116. An advertising generator engine 116 compares the keywords from a social media provider 104 to keywords in an advertisement database 115 to identify relevant advertisement content. Advertisement is updated as a user 101 changes the post they are viewing by calling the advertising generator engine 116 with the new post subject and content.

In another embodiment, advertisement content is further targeted with user data from the profile database 105, which may include relationship status, gender, age, and location. In this case, rules may analyze the informational advertisement tags in the advertisement database 115, such as location, and match the background keyword to determine if the advertisement is applicable to the user and display via the display engine 112. For instance, to check if a ticket advertisement for a basketball game is in the location of a user 101. In another instance, a married user should not be shown dating site advertisements.

According to some embodiments, the advertisement itself may be further targeted by using the background data of a user 101 from the profile database 105, such as gender and age. Advertisement may consist of a static and dynamic portion. The static sections may include the product information. The dynamic portion may be updated in the form of images, language, color, etc. In this case, rules may analyze the dynamic advertisement tags in the advertisement database 115, such as gender and age, and match the user background keyword to determine content for the dynamic portion of the advertisement which may be displayed via the display engine 112. For instance, for a basketball game ticket advertisement, when a user 101 is male, dark colors like black and blue may be used with a male model attending the game. The same advertisement for a female user 101 may be lighter colors like pink and a female model could be displayed attending the game. In another embodiment, frequency of how often advertisement is changed may be relevant for pages that a user 101 may view for a longer period of time, such as a video. In this embodiment, a cartoon video may have advertisements displaying more quickly. Similarly, a horror movie preview may include more genre specific advertisement.

In another embodiment, rules may also be predictive in nature to check if, based on the current state of a user 101, they may be expecting to view or looking to purchase something in the near future. Content from the posting database 107 and profile database 105 may be used to determine predictive advertising for a user 101. Predictive content and statistics may be associated in the advertisement database 115 or external information and engines 117 that may be accessed, for instance via an API. Posting and profile data may be used to calculate advertising targets such as dates. For instance, if a user creates a post that he or she just purchased a new car, advertisers may determine the next time the user may require getting the oil change by using estimated mileages for the particular car. Advertisers may present a user with a voucher for an oil change at a local dealership at the estimated time. They may further determine the timing of the oil change by calculating the average distance the user is required to travel based on his or her employer location and other locations via check-ins, likes, purchase history, etc. In another example, married couples generally buy housing a certain amount of months after they get married; therefore, real estate advertisement may be shown the appropriate amount of time after their relationship status in the profile database 105 changes to married.

In another embodiment, an advertising generator engine 116 may provide the next best advertisement if there is not an exact match to the keyword. The related keywords in the advertisement database 115 may be used to determine similar activities and/or products based on intent of the search. The advertising generator engine 116 may match the related keyword from the advertisement database 115 to the post subject keyword or search keyword from the original search. For instance, if a user searches for a sporting venue on a social media provider 104, sporting venue tickets may show up as advertising. However, if venue tickets are sold-out, the advertising generator engine 116 may determine that the user intent is to watch the game and present user 101 with a local bar which may be hosting the specific event based on related tag of basketball.

According to some embodiments, an advertising generator engine 116 may also add relevant social media information such as company page, check-ins, positive acknowledgements (e.g. likes), and comments from a social media provider 104 with the advertising data to create a personalized advertisement. The company or product identifier may be retrieved directly from the advertisement database 115 and the associated company or product information may be matched from the profile database 105 for company profiles and post database 107 for check-ins, comments, and likes. This is then passed to a display engine 112 of a social media provider 104 to be displayed to a user 101. Companies may be able to pay higher for advertisement to display more positive social media related data.

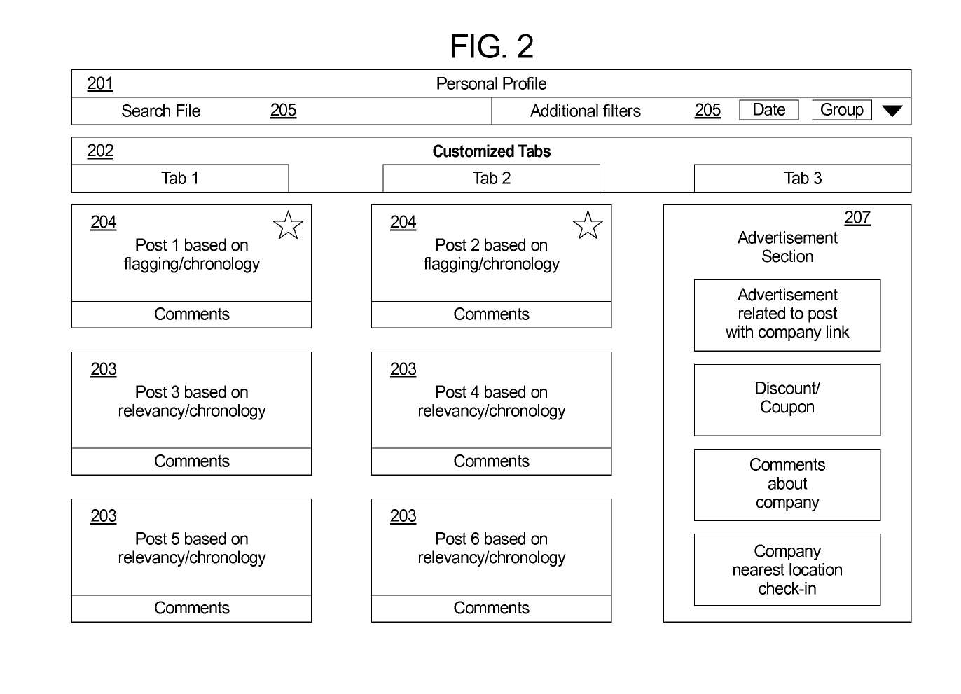

FIG. 2 is an exemplary screenshot of a social tagging page. Personal profile 201 displays basic information about a user 101, including name, location, and interests. User 101 may have an option to customize tabs 202 they want displayed based on categories and order placement. Tabs may be displayed across the top of the page and may be selected to move from one tab to another. Tab settings may be changed directly in the tab area or a settings page, which may be updated in the personalization component 111. The following may be options for the customized tabs: Sports, Comedy, Business, Entertainment/Reviews, News, and Personal. A Personal tab may compile all the important recent events in the lives of associated members, such as graduations, marriages, and births.

Posts 203 of associated members may be displayed by relevancy to interests and background in each chosen tab 202. Posts 203 may be indexed based on tags for text, as well as graphics such as pictures and logos. Direct posts 203 content that matches to interest keywords may be displayed first. An additional factor of the background keyword may be applied. These factors may be weighted and applied to the interest matching to further refine the order of the posts 203. This relevancy matching may or may not be displayed. For instance, if someone has an interest in basketball and is located in Chicago. When they select the Sports tab, the posts related to the Chicago Bulls basketball team may be displayed first. But if a user 101 specifies interest in the Los Angeles Lakers basketball team and is located in Chicago, the Los Angeles Lakers posts may be displayed first and then the Chicago Bulls posts may be displayed. The remaining posts 203 content that matches the subject but not necessarily the interest, and may still apply to the background, may then be displayed such as Chicago Bears football team.

In one embodiment, the method may allow a user an option to flag certain items which a user 101 deems to be important, to be viewed by themselves or associated users. All posts 203 within a tab 202 may have an option to flag priority 204 with a button or graphic within or next to post 203, additional setting such as time period may also be displayed. The content may be flagged for a limited or unspecified amount of time. This content 204 may be given higher emphasis than other posts 203, in the form of color or location, such as moving to the top of a page. The priority flag 204 may be kept in the personalization component 111 for the particular post 203 identifier and leveraged by the display engine 112 to display priority content to a user 101.

In another embodiment, all posts 203 within a tab 202 may have an option to like or dislike, such as a button or graphic within or next to the post 203. If user 101 chooses to like a post 203, other posts 203 created by that associated user 101 may be displayed more frequently or higher within the tab 202. If user 101 chooses to dislike a post 203, other posts created by that associated user 101 may be displayed less frequently or not at all within the tab 202. These associated users settings per tab may be stored in the personalization component 111 to either not display posts 203 or display more often as specified. For instance, user 101 may not agree with another user's opinions on Sports, but they are a good friend so they may want to hide them only in the Sports tab 202. Similarly, if a user 101 likes another user's fashion opinion but does not appreciate the amount of personal information they share about their family, they may like them in the Entertainment tab 202 but hide them in the Personal tab 202.

A search field 205 may be shown towards the top of the page or another central location, which provides the ability to search posts 203 based on subject tag or content. User 101 is presented with a dropdown list as they are typing based on available topics from within their own posts and associated user's posts 203. User 101 may be presented with filtering options 206 to organize the information, for instance, by day/date/or key event or holidays and within groups such as friends or family. User's 101 own post 203 may be displayed first. It may further show search results based on relevancy to user 101 which may include interests and proximity. These may be displayed under any directly relevant results. The relevancy matching may or may not be displayed.

In another embodiment, advertisements 207 may be created based on posts 203 that are being viewed by and relevancy to a user 101. The post 203 subject is used to determine advertisement 207 and may be further refined by basic profile information 201, such as location. Advertisements 207 may be updated as a user 101 maneuvers through a page. This may be done when movement in the page is detected or after a time interval. For instance, if a user 101 is viewing a post about the Chicago Bulls, if it is basketball season an advertisement may be displayed to purchase tickets for an upcoming game. As a user changes to a post 203 about the Chicago Cubs, because it is not baseball season, an advertisement may be displayed for purchasing a jersey. Relevancy to content may be displayed, possibly in the form of a personal statement.

According to some embodiments, advertisement 207 may be interactive where they may purchase an item without leaving an active page. Purchases may be applied to current page or a saved wish list. Purchasing content may be associated in the advertisement database 115 or external information and engines 117 that may be accessed, for instance via an API. Purchasing preferences, such as size or shipping address may be stored in the personalization component 111 for specific keywords or advertisement 207. Advertisement 207 may have additional details within the advertisement space, such as underneath or next to the main content. This may include a direct purchasing link, which may expand a box on the page to complete the order or have a pop-up box. Details may also be saved and auto-populated such as size and shipping city.

Advertisement 207 may also display additional details within the advertisement space, such as underneath or next to the main content for value-added content. This may include the following relevant information: company link (within site or external), nearest location check-in, additional discounts or coupons, and comments made about a company by associated users. Affiliated discount content may include text about a discount, links to purchase (if external) and/or additional graphics. Discount content may be associated in the advertisement database 115 or external information and engines 117 that may be accessed, for instance via an API.

In one instance, advertisement 207 may also display hints for a user 101 to make the best decision based on value. Advertisement 207 may have these additional details within the advertisement space, such as underneath or next to the main content. Affiliated content may be displayed in the form of texts or graphics, such as a venue diagram for a sporting event or diamond cuts for engagement rings. Best value content may be associated in the advertisement database 115 or external information and engines 117 that may be accessed, for instance via an API.

In one embodiment, advertisement 207 may be further interactive by having a section to input questions within the advertisement space, such as underneath or next to the main content. This may be treated as a comment post 203 and associated with the advertisement 207 in the personalization component 111. Responses may also be associated with the original post 203 and updates may be displayed via the personalization component 111 to the displayed engine 112 and through standard post 203 notification.

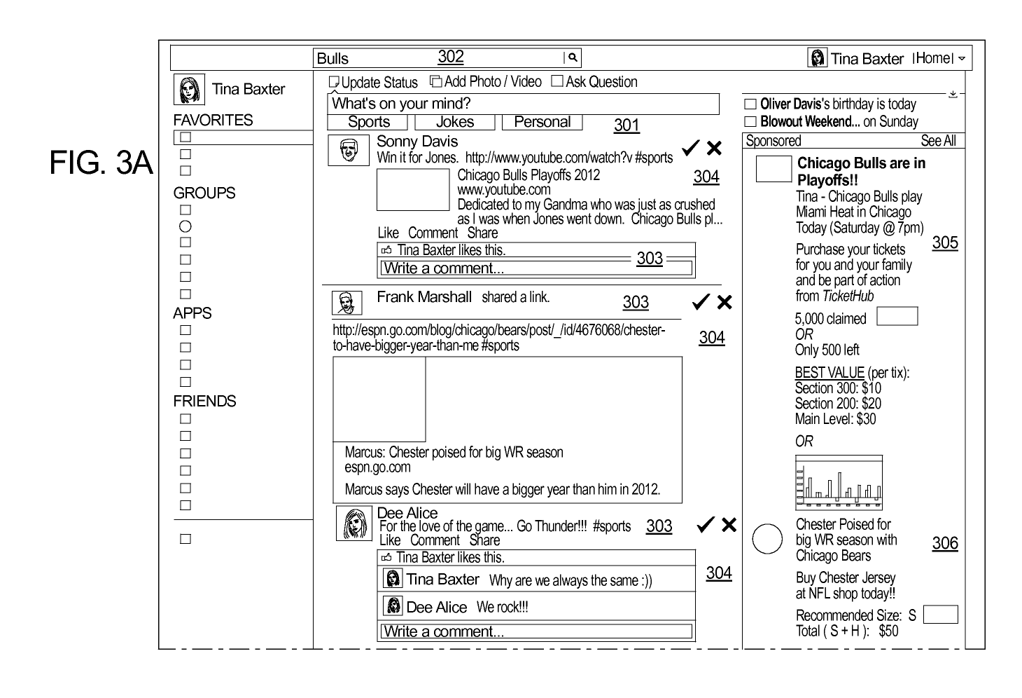

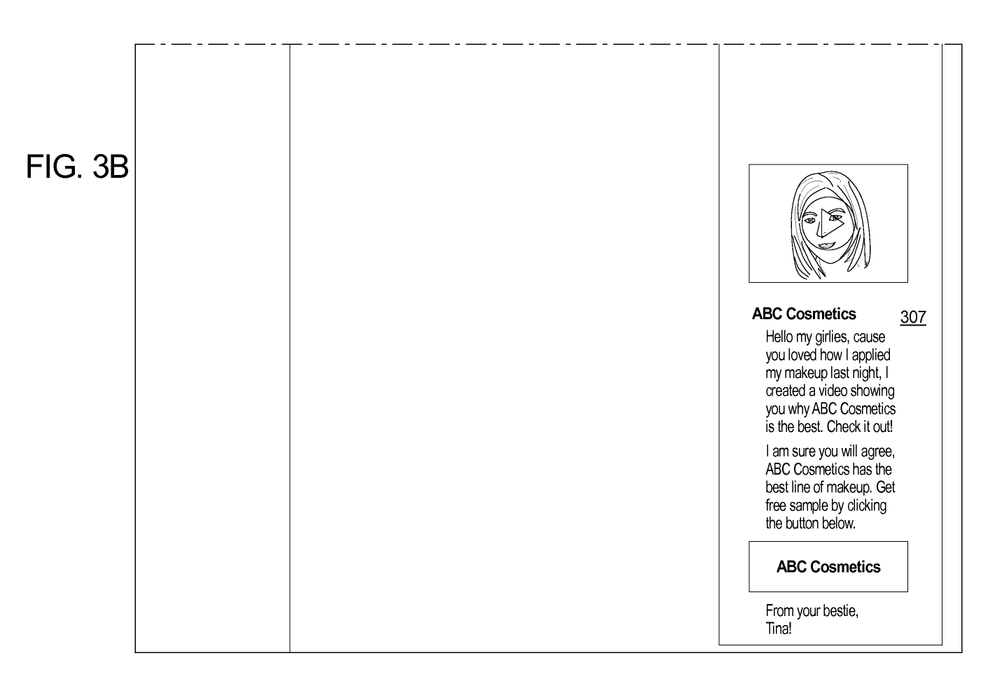

FIG. 3A is an illustration of posts and related social advertising. User 101 Tina Baxter has chosen customizable tabs 301 of Sports which may hold any sports related news and posts; Comedy which may hold any jokes or other funny posts being shared or created by associated users; and Personal which may hold personal posts from associated users such as a vacation, graduation, or wedding. She has currently chosen the Sports tab 301. Here posts 303 tagged with Sports are posted based on Tina's location of Chicago and interest of basketball. Tina may also perform a search in the search field 302 where she can make a search for relevant posts. With her search entry of Bulls in the Sports tab, it may be inferred that she means the Chicago Bulls basketball team. A post 303 from associated user Sonny Davis regarding the Chicago Bulls is posted first. This is followed by a post 303 from associated user Frank Marshall about the Chicago Bears because Tina is a resident of Chicago so she may have interest in another Chicago sports team. Further down, a post 303 from associated user Dee Alice is shown for the Oklahoma City Thunder which is also a basketball team which the Chicago Bulls played previously. Tina may choose to not like Sonny's post 303, because it is not factual. She may do so by choosing the X 304 marked next to the post. In the future, Sport's posts 303 from Sonny may be limited or not presented at all.

When Tina is viewing the Chicago Bulls post 303 on the right hand side she may see advertising 305 to buy tickets for a Chicago Bulls game because it is currently basketball season. She may directly see the best value seats from the ticket vendor and has a direct link to buy. When she scrolls further down to the Chicago Bears post 303, she may see advertising 306 to buy a jersey of one of the Chicago Bear's player because it is currently off season for football. She may purchase this through a one-click or like feature. Her preference for Small size is saved so she may directly click a button to finalize the purchase.

FIG. 3B is a continued illustration of the advertising page. On the bottom of the page, Tina may see an advertisement 307 that she created for a lipstick product she really likes. This includes a personalized message to all of her friends that may view this advertisement 307.

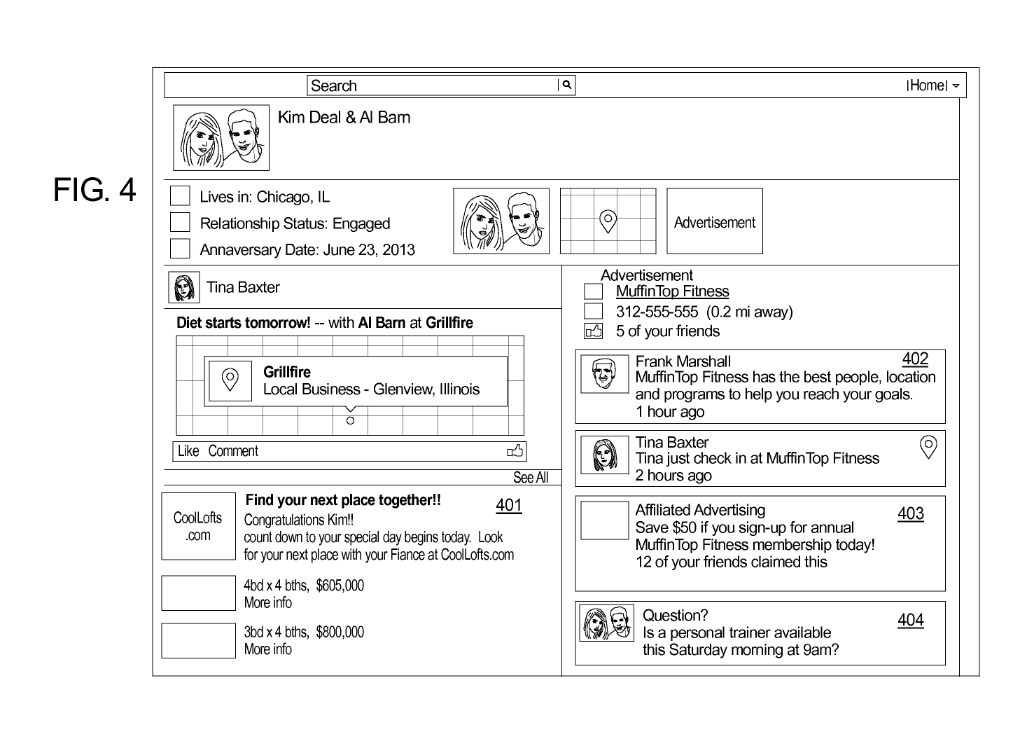

FIG. 4 is an illustration of a profile and related social advertising. Kim Deal has a relationship status of engaged. Because of this, she is being presented with advertisement 401 for real estate in a mutual interest location with her fiancé Al Barn since statistics prove that most newly married couples may look for a new condominium or house together. She has also created a post that states, “Diet starts tomorrow”. Since direct advertisement was not available for diet plans, the next best advertisement 402 has been generated for a fitness center near her location. Additional value-add social media information is also provided within the advertisement 402, such as associated user Frank Marshall posting a comment about the fitness center and associated user Tina Baxter checking-in to the fitness center. Affiliated marketing in the form of an external coupon link 403 for $50 savings has also been generated within the advertisement 402 that Kim may redeem at the fitness center. Towards the end of the advertisement, a comment box is visible 404 for Kim to ask a question, which she has asked “Is a personal trainer available on Saturday at 9 am?”

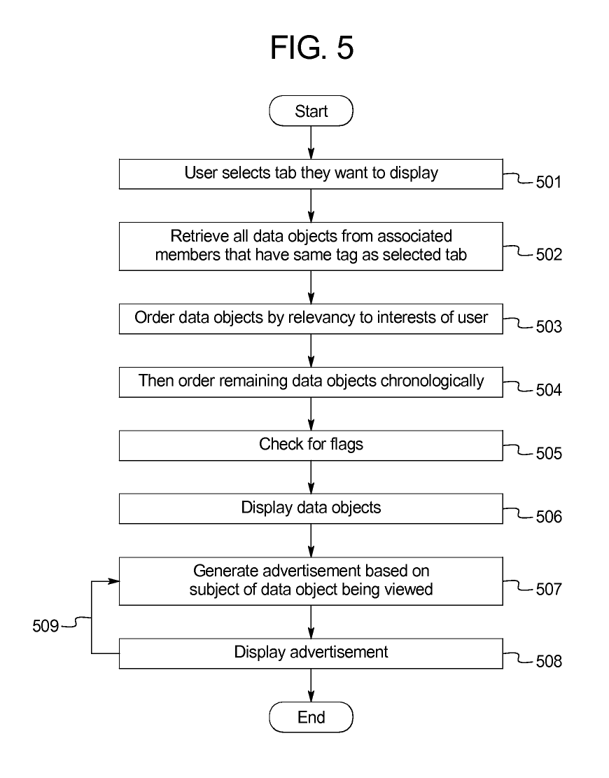

Referring now to FIG. 5, a flow diagram of an exemplary process for generating a social tagging page. At step 501, a user 101 selects a tab 202 from their customized list for display which may be stored in the personalization component 111. For example, Sports.

At step 502, data objects may be retrieved by the news feed engine 108 from a posts database 107 related to a tab 202 selected in step 501 for which associated members have posted with the same subject tag.

At step 503, data retrieved in step 502 from a posts database 107 is sorted by relevancy to user's 101 specified interest from their profile data 105. For example, user 101 may have interest in the sport of basketball. At step 504, a news feed engine 108 then sorts data objects retrieved in step 502 chronologically within the relevant and remaining posts. For instance, any posts related to basketball may be displayed higher up. Since hockey season is at the same time, once the relevant basketballs posts are shown, hockey posts may then be displayed chronologically.

At step 505, a news feed engine 108 may check for any flags 204 specified by a user 101.

At step 506, data objects retrieved in step 502 and organized in steps 503, 504, and 505 may be displayed in a social media provider 104 with additional settings from the personalization component 111 via a display engine 112.

At step 507, based on a keyword subject of the data object that is currently being viewed by a user 101, an advertising generator engine 116 may retrieve advertisement from an advertisement database 115 to display relevant advertisement to a user 101.

At step 508, advertisements retrieved from step 507, may be displayed via a display engine 112.

At step 509, as a user 101 scrolls and the subject of the data object changes, an advertisement may be updated by repeating step 507.

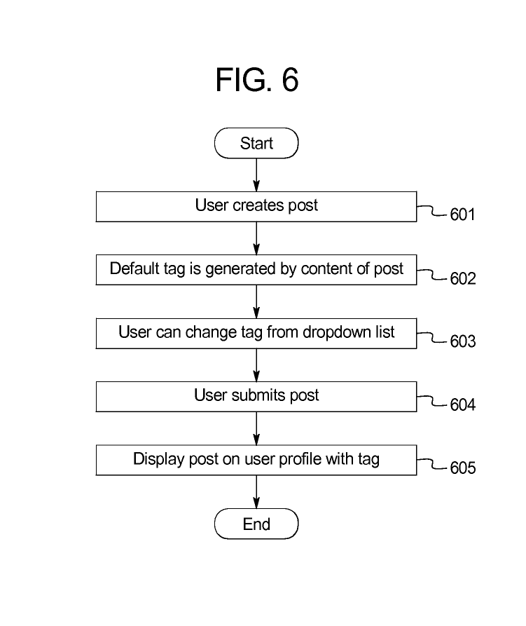

Referring now to FIG. 6, a flow diagram of an exemplary process for generating a post in a social tagging page. At step 601, a user 101 may create a post entry for display in a social media provider 104.

At step 602, based on the subject of the entry in step 601, a default tag to identify the subject may be generated by a tagging engine 109. For instance, if a user posts a link from ESPN.com the default generated tab may be Sports. At step 603, a dropdown list may also appear next to the post to change the tag that is generated in step 602.

At step 604, user 101 may then submit the post with the associated tag. This may then update a posts database 107.

At step 605, the post may now be available for display to a user 101 and any associated users where relevant in a social media provider 104.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

I claim:

1. A system for dynamically presenting and organizing social media by subject matter comprising:
a posting database including a plurality of posts, wherein each post includes post content and one or more post tags; and
a display engine posting the plurality of posts to a client machine, wherein the plurality of posts are posted in response to receiving a post tag selection from the client machine.

2. The system of claim 1 wherein each post is associated with user data associated with a profile database, further wherein the user data associated with each post includes a grant for the first user to access the post.

3. The system of claim 1 wherein the display engine provides a currently viewed post and an advertising generator engine selects an advertisement from an advertisement database based on a keyword comparison between keyword data associated with the currently viewed post and keyword data associated with the selected advertisement.

4. The system of claim 3 wherein the display engine displays the selected advertisement in association with the currently viewed post.

5. The system of claim 1 wherein the display engine displays a news feed based on at least one user selected tag received through a personalization component, further wherein an advertising generator engine selects an advertisement from an advertisement database based on a keyword comparison between keyword data associated with the at least one user selected tag and keyword data associated with the advertisement, and the display engine displays the selected advertisement in association with the currently viewed post.

6. The system of claim 1 wherein:
the display engine provides a currently viewed post;
an advertising generator engine selects an advertisement including a static portion and a dynamic portion from an advertisement database based on a keyword comparison between keyword data associated with the currently viewed post and keyword data associated with the advertisement;
the advertising generator engine selects amongst a plurality of dynamic advertisement content associated with the selected advertisement based on data received from a profile database; and
the display engine displays the selected advertisement including the selected dynamic advertisement content in association with the currently viewed post.

7. The system of claim 1 wherein a search engine receives a search request from a client machine and identifies a related one or more posts from the posting database, the display engine causes the identified one or more posts to be displayed on the client machine and the identified one or more posts are displayed in prioritized order based at least in part on data received from a profile database.

8. A system for dynamically presenting and organizing social media by subject matter comprising:
a news feed engine adapted to assemble a list of one or more posts from a posting database, wherein each post includes post content and one or more post tags, further wherein the news feed engine assembles the list of one or more posts based on a comparison of the post tags and at least one user selected tag received through a personalization component; and
a display engine adapted to display the post content assembled list of one or more posts in a news feed associated with a first user.

9. The system of claim 8 wherein each post is associated with user data associated with a profile database, further wherein the user data associated with each post includes a grant for the first user to access the post.

10. The system of claim 8 wherein the personalization component is further adapted to receive user selected preferences that instruct the display engine as to the format in which to display the assembled list of one or more posts from the posting database.

11. The system of claim 8 wherein the display engine displays the assembled list of one or more posts in prioritized order based on relevancy to data associated with the first user in a profile database.

12. The system of claim 8 wherein the display engine displays the assembled list of one or more posts in prioritized order based on relevancy to data associated with the first user in a posting database.

13. The system of claim 8 wherein the display engine provides a currently viewed post and an advertising generator engine selects an advertisement from an advertisement database based on a keyword comparison between keyword data associated with the currently viewed post and keyword data associated with the selected advertisement.

14. The system of claim 13 wherein the display engine displays the selected advertisement in association with the currently viewed post.

15. The system of claim 8 wherein the display engine displays a news feed based on at least one user selected tag received through a personalization component, further wherein an advertising generator engine selects an advertisement from an advertisement database based on a keyword comparison between keyword data associated with the at least one user selected tag and keyword data associated with the advertisement, and the display engine displays the selected advertisement in association with the currently viewed post.

16. The system of claim 8 wherein:
the display engine provides a currently viewed post;
an advertising generator engine selects an advertisement including a static portion and a dynamic portion from an advertisement database based on a keyword comparison between keyword data associated with the currently viewed post and keyword data associated with the advertisement;
the advertising generator engine selects amongst a plurality of dynamic advertisement content associated with the selected advertisement based on data received from a profile database; and
the display engine displays the selected advertisement including the selected dynamic advertisement content in association with the currently viewed post.

17. The system of claim 8 wherein a search engine receives a search request from a client machine and identifies a related one or more posts from the posting database, the display engine causes the identified one or more posts to be displayed on the client machine and the identified one or more posts are displayed in prioritized order based at least in part on data received from a profile database.
